(19) United States
(12) Patent Application Publication
(10) Pub. No.: US 2003/0167449 A1
(43) Pub. Date: Sep. 4, 2003

(54) Method and system for producing enhanced story packages

(76) Inventors: Bruce Frederic Michael Warren, Vancouver (CA); John James Ollivier, Vancouver (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/362,836

(22) PCT Filed: Sep. 18, 2001
(86) PCT No.: PCT/CA01/01309

(30) Foreign Application Priority Data
Sep. 18, 2000 (CA) 2,319,979

(51) Int. Cl. G06F 17/24; G06F 17/21

(52) U.S. Cl. 715/531; 715/500.1; 715/530

(57) ABSTRACT

A method and system for creating enhanced content by combining rich media elements such as video, audio, related links, text, polls, and graphics into enhanced story packages. In addition to creating the story package, this method and system archives and manages all of the story elements as well as the completed story in a database of content. The system is a browser based software product that allows remote access to all of its features from any Internet terminal. Content creators can create and publish enhanced content from any Internet terminal or home, at work or in a foreign country, editors can edit the content immediately and the enhanced story package can be cross-published to multiple platforms simultaneously. As soon as a story is published within the system backend, it is formatted and published instantly to the Internet, digital set-top boxes, handheld devices, and Web-enables cellular phones in formats appropriate to each platform by selection of appropriate assets from within the enhanced story package.

### FIELD OF THE INVENTION

The present invention relates generally to methods and systems for preparing and producing content for broadcasting. More particularly, the present invention relates to convergence solutions for preparing and broadcasting content across multiple platforms.

### BACKGROUND OF THE INVENTION

With the growth of the Internet there is growing trend to produce interactive content. For example, major broadcasters commonly have Internet Web sites at which users can review video clips of the latest news, and can follow links to other related items, and more in depth coverage. Users are also adopting new communications technologies and devices, such as personal digital assistants, Web-enabled devices, and emerging digital TV/set-top boxes, at a great rate, and media publishers are eager to exploit the abilities of these technologies and to create interactive and enhanced content for them. The content that can be displayed in these various technologies differs, and content created for Web access to be displayed on a computer screen is not necessarily appropriate for publication to a Web-enabled cellular phone with a four line alphanumeric display. Therefore, there is clearly a need for a system that can cross-publish interactive content to multiple platforms.

The need to create interactive and rich media content poses other problems as well. For example, TV media content is currently created by numerous individuals at different locations, such as a reporter who collects the information in the field and produces a text report, a video technician who shoots video footage, and an audio technician who records appropriate audio clips. Producers, directors, editing staff, and others, must then collate the raw material, add appropriate interactive features, and publish the content to appropriate media. Currently, there is no system that provides such functionality in a single application, nor is there a simple way for all the people creating the content to interact together. The speed with which media content must be created in today's world is also ever increasing, and it is becoming more important that media content be more easily and efficiently produced. Therefore, there is clearly a need for a system that can simplify the creation and management of interactive content, and that permits remote access by the various contributors from different locations.

There are several products that permit the production or viewing of interactive content. For example, HyperTV™, by HyperTV Networks Inc., is an Internet software application for viewing interactive content on the Internet. HyperTV™ content is designed for viewing in synchronization with standard television programming. HyperTV™ facilitates interactivity in the form of chat, trivia, games, advertising, and e-commerce. While watching a traditional broadcast program on a television, HyperTV™ viewers can interact with one another on their PC's over the Internet. HyperTV™ demands users participate in two activities at the same time: watch television and surf the Internet, and does not provide interactive content creation or management. HyperTV™ reaches only a selective Internet audience, as it does not cross-publish content to set-top-boxes, handheld devices, or cellular phones.

iMag™, by innovatv.com, is a software application that permits the creation of video-centric information stories combining video, audio, related links and timed interactive triggers into a news magazine format. However, iMag™ is only a production and distribution tool. iMag™ does not facilitate content management or facilitate remote access. iMag™ publishes only to the Internet, and does not reach set-top boxes, cell phones, or handheld devices.

OpenAuthor™, by OpenTV, Inc. is a drag and drop tool for developing interactive content for the OpenTV™ set-top-box operating system. OpenAuthor™ is not a content management tool and does not offer remote Internet access to its users. OpenAuthor™ content reaches only OpenTV™ enabled set-top boxes and does not cross-publish to the Internet, cell phone, and handheld device markets.

Finally, MediaSuite™, developed by SofTV, Inc., allows producers to take digital video content, (Real or Windows Media), add timed interactive triggers (e.g. when a player scores a goal—the trigger—the players statistics, graphics, etc. are brought up), and publish the interactive content on the Internet. However, MediaSuite™ does not offer content management features or remote Internet access. It does not cross-publish content to any medium except the Internet, and, therefore, MediaSuite™ content reaches only an Internet audience, as it does not cross-publish to set-top-boxes, handheld devices, or cellular phones.

It is, therefore, desirable to provide a media convergence method and system for producing interactive content that permits remote access by various contributors, provides content management, and permits cross-publication to multiple platforms.

### SUMMARY OF THE INVENTION

It is an object of the present invention to obviate or mitigate at least one disadvantage of previous systems and methods for producing interactive content, and publishing the content to multiple platforms. Generally, the present invention provides a method and system for creating enhanced content by combining elements such as video, audio, related links, text, polls, and graphics into enhanced story packages. In addition to creating the story package, this method and system archives and manages all of the story elements as well as the completed story in a database of content. The system is a browser based software product that allows remote access to all of its features from any Internet terminal. Journalists can create and distribute enhanced content from any Internet terminal—at home, at work, or in a foreign country, editors can edit the content immediately and the enhanced story package can be cross-published to multiple platforms simultaneously. As soon as a story is published within the system backend, it is formatted and published instantly to the Internet, digital set-top boxes, handheld devices, and Web-enabled cellular phones in formats appropriate to each platform by selection of appropriate assets from within the enhanced story package.

In a first aspect, the present invention provides a method for publishing enhanced story packages. The method consists of providing a plurality of assets in a plurality of content sources. The assets can be edited, retrieved or created, as appropriate. The assets are then associated, or linked, to form an enhanced story package. At least one template is provided to map the plurality of content sources to site sections on a platform. And, finally, the enhanced story package is published for display on the platform. This permits different assets to be displayed on different platforms.

In a further aspect, the present invention provides an enhanced story package for an interactive publication. The enhanced story package includes a plurality of assets selected from different content sources, and associations between the plurality of assets to permit their display on a publication platform. The plurality of assets are chosen from media assets, interactive assets, and external assets, and are preferably provided in Extended Markup Language (XML) to the publication platform.

In yet another aspect, the present invention provides a system for publishing enhanced story packages. The system consists of a content server for maintaining assets in content sources, and for storing a profile of an enhanced story package associating a plurality of the assets, a plurality of templates for specifying the content sources that can be displayed on each of a plurality of platforms, and a publisher for publishing selected assets of the enhanced story package to the plurality of platforms according to their respective templates. The system can also include other editing and authoring tools, or can be associated with such tools.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a diagram of a conceptual overview of the present system;

FIG. 2 is a is a general architecture diagram of the system of FIG. 1;

FIG. 3 is a diagram of an enhanced story package according to the present invention;

FIG. 4 is a diagram of the method of the present invention;

FIG. 5 is a diagram of the publication process of the present invention;

FIG. 6 is a diagram of the publication architecture according to the present invention;

FIG. 7 shows an embodiment of a user interface for the system of FIG. 1;

FIG. 8 shows a context window of the user interface of FIG. 7;

FIG. 9 shows a content window of the user interface of FIG. 7; and

FIG. 10 shows navigation and resource bin views of a navigation window of the user interface of FIG. 7.

### DETAILED DESCRIPTION

Generally, the present invention provides a method and system for creating enhanced content by combining elements such as video, audio, related links, text, polls, and graphics into enhanced story packages. In addition to creating the story package, the present invention archives and manages all of the story elements as well as the completed story in a database of content. The following description is based on the creation of news content, but those of skill in the art will understand that the present system and method can be used to create, manage and publish or broadcast any content that is primarily video-based, such as news magazines, serial TV, music videos and other multimedia productions.

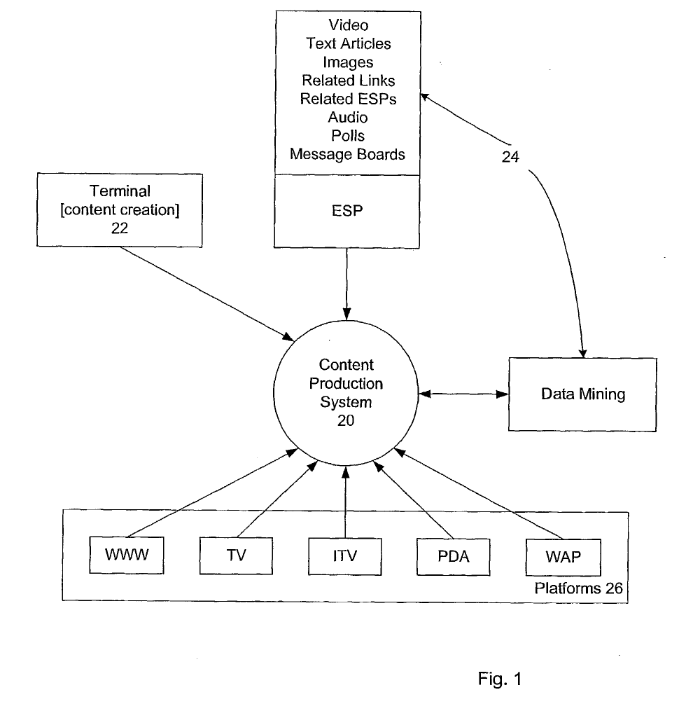

Referring to FIG. 1, the system 20 of the present invention is shown conceptually in relation to acquisition and publication platforms. System 20 is a browser based software product that allows remote access to all of its features from any Internet terminal 22. Journalists can create and distribute enhanced content from any Internet terminal 22—at home, at work, or in a foreign country. Editors can access, modify and associate the enhanced content with other content stored at various sites 24, and the resulting interactive content can be cross-published to multiple platforms 26 simultaneously. As soon as a story is activated for publication within the system 20, it can formatted and published instantly to the Internet, digital set-top boxes, handheld devices, Web-enabled cellular phones, and other suitable platforms 26.

The conceptual framework of the present invention is based upon research of newsroom practice, where certain people in the newsroom perform well-defined roles within a linear process. The model draws from this sequential process, whereby a story is assigned, researched, created, edited and approved, and a news broadcast is aired. Based on this model, system 20 allows users to create interlaced rich media packages, which are automatically displayed on a Web site, handheld device, Web-enabled cell phone or broadcast on interactive TV.

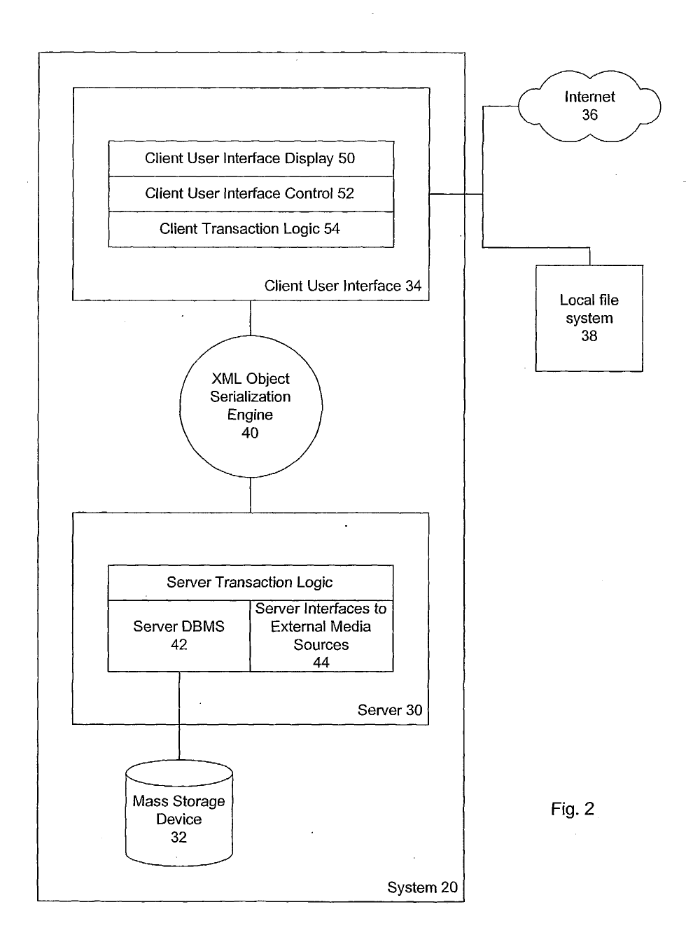

FIG. 2 shows the general architecture of system 20. System 20 consists of a server 30 connected to one, or more, storage devices 32 for maintaining a database of current enhanced story packages. A client user interface (UT) 34, which is generally loaded on a user's terminal, permits a user to interact with server 30. Typically, a user will access server 30 over the Internet 36, or other appropriate network such as a LAN. The user will also typically have access to locally stored files through a local file system 38, such as is normally resident on the user's own computer. In a presently preferred embodiment, UI 34 and server 30 communicate and transmit information in an Extended Markup Language (XML) format through the use of an XML object serialization engine 40.

Server 30 consists of a conventional server database management system 42 for managing the enhanced story packages database found in storage device 32. Server 30 also includes interfaces 44 that interface with external media sources as will be further described below, and transaction logic 46 for managing the interactions with UI 34. UI 34 consists of a client user interface display 50 suitable for displaying a Web browser, a client user interface control 52 such as a conventional Web browser, and client transaction logic 54 for managing interactions with server 30.

The identified users, or actors, of the method and system of the present invention are people who interface with system 20. Each actor defines a particular role. One physical person may be represented by several actors, because that person takes on different roles with regard to the system; or several physical people might be represented by one actor because they all take on the same role with regard to the system. Identified actors of system 20 can include an editor, assignment editor, line-up editor, Web editor, researcher, reporter, librarian, cameraperson, video editor, producer, director, advertiser, administrator, manager, and system administrator.

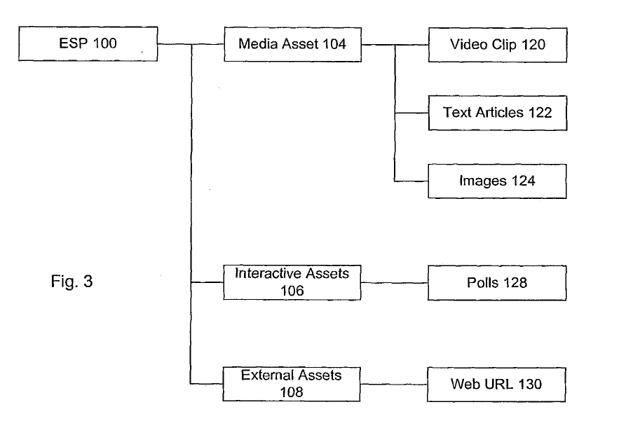

Using system 20, actors create and edit an Enhanced Story Package (ESP) 100. ESPs 100 consist of a main story, related video streams, text information, hyperlinks, ads and other assets that are linked together, in order to be published on a publication platform. Referring to FIG. 3, the general format of an ESP 100 is shown. The ESP 100 is a collection of assets 102, selected from media assets 104, interactive assets 106, and external assets 108 that can be displayed together as a single story. On their computers, interactive TV sets or handheld units, viewers will get an interlaced rich media package where a main story, related video clips, text information, hyperlinks, ads and other assets are all pre-linked together, and displayed in a format suitable to the platform being used.

Media assets 104 include video clips 120, text articles 122 and images 124. All of these can be added to an ESP 100 to create a rich media presentation of news stories. Media assets 104 can be generated in a variety of ways, created by the journalists themselves or imported from other sources, such as existing archives or wire services. Interactive assets 106 are assets with which viewers can involve themselves. These include polls 128 and message boards. Interactive assets 106 are generally provided by the news production team, for any ESP that requires them. External assets 108 can be links 130 to external Web sites, or other externally accessible media. The assets 102 can be located in external file storage locations, in servers maintained by other systems, or can be created specifically for the particular ESP 100 and stored in the database 32 maintained by system 20.

When assets 102 are associated to compose an ESP 100, their storage location does not physically change. A link between one asset 102 and another is simply established, and the link relationships and asset locations are maintained in database 32. Linked assets 102 form an ESP 100, and some assets 102 may be associated with many ESPs 100. Since ESPs 100 are comprised of a collection of assets 102, unconnected assets 102 are potential ESPs 100 and, therefore, may be latent ESPs 100. As all assets 102 are potential components of latent ESPs 100 (stories that have not yet been defined), the UI 34 respects that by allowing assets 102 to be accessed independently. Similarly, a pre-defined ESP 100 can also be an asset for another ESP 100, and can be linked to the new ESP 100 as would any single asset.

Generally, to create an ESP 100, an actor, typically an editor, will create an ESP shell containing suitable identification information for the ESP 100, such as a slug, a headline, a byline, a synopsis and/or an identification number. This information is stored by system 20 to uniquely identify the ESP 100. The actor can also choose whether to associate, or attach, advertising with the ESP 100. Once the ESP 100 has been defined, assets 102 can be created, associated and edited as desired to achieve an appropriate content for the ESP 100.

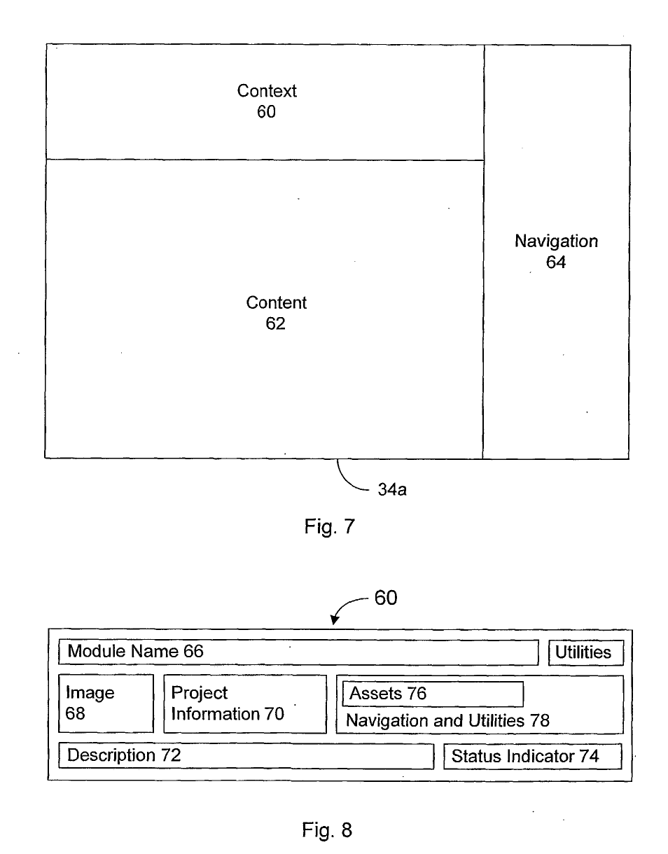

Referring to FIG. 7, a presently preferred UI 34a for creating an ESP 100 is shown. UI 34a consists of a context window 60, a content window 62, and a navigation window 64. As shown in FIG. 8, the context window 60 includes a module bar 66 that identifies the current module name, a default image 68 to be associated with the ESP 100, a project information area 70 that can include the ESP headline, creation date, site section name, etc. A description bar 72 can include the headline, or other descriptor. Status indicators 74 indicate the current status of the ESP (e.g. active, inactive, etc.), while an asset bar 76 provides links to the various assets that are associated with the ESP, and which can be listed in the content window 62. Different assets are preferably represented by buttons or icons. A navigation and utilities bar 78 provides access to functions such as “view”, “save”, “publish”, “edit”, etc. as appropriate.

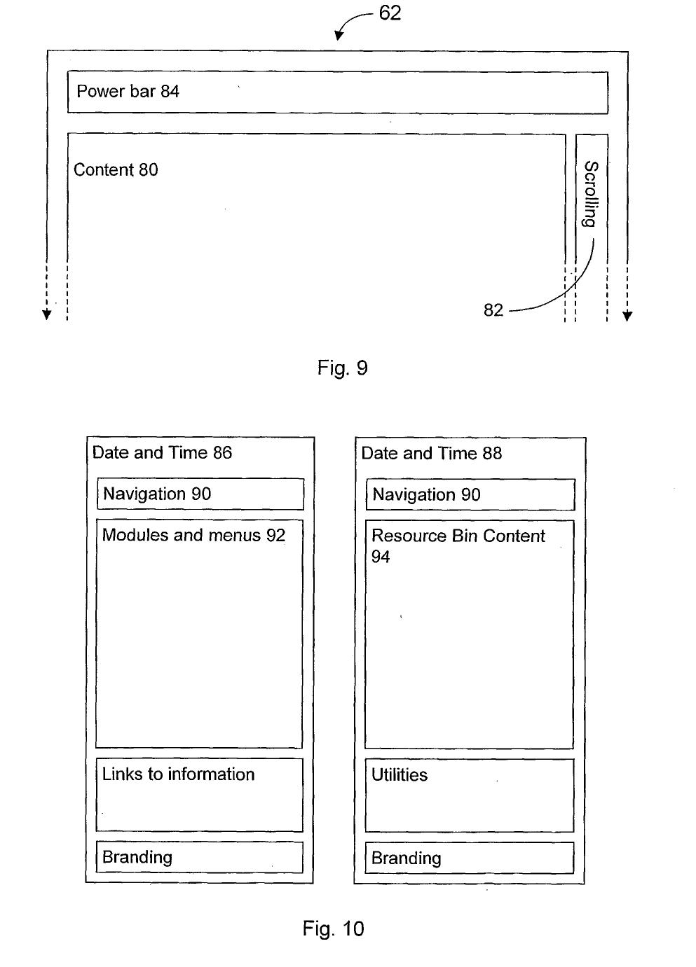

Referring to FIG. 9, the content window 62 is the window in which the user has the main interaction with system 20. The content window 62 includes a content display 80. The content display 80 can display, for example, lists of ESPs, text or images for editing, screens for entering or modifying identification information for an ESP, search screens, video clip viewers, etc. Depending on the type of content being displayed, or the function(s) being performed, other items, such as scroll bar 82, or power bar 84, may also be activated.

The navigation window 64, as shown in FIG. 10, can be switched between a navigation view 86 and a resource bin view 88 by user selection in the navigation bar 90. In the navigation view 86, the user can select between the modules and menus displayed in the modules and menus display 92. The resource bin view 88 is for the storage and retrieval of assets and ESPs. A resource bin content display 94 displays new resources, such as assets and ESPs, and permits them to added or removed.

After the ESP 100 has been created, any actors can be given access to it, and can associate assets 102 to the ESP 100, and can edit the assets. Every ESP 100 has a status associated with it. This status tells all actors of the news production team the stage of readiness of that ESP 100 for publication. An ESP 100 can have a variety of statuses, including usable, cancelled, in progress and archive. A usable ESP is ready to be published and will be displayed if it is attached to a site section or is a finished ESP that has not been approved for publication. A cancelled ESP is a finished ESP that is not to be published. An ESP in progress is being built and is not ready for publication. An archived ESP is a finished package that is no longer current but still available to be published. Most ESPs are also classified according to subject matter. For example, classifications can include None, Arts, Culture and Entertainment, Crime, Law and Justice, Disasters and Accidents, Economy, Business and Finance, Education, Environmental Issues, Health, Human Interest, Labour, and Lifestyle and Leisure.

To associate an asset 102 to the ESP 100, the actors can create an asset and associate it directly to the ESP 100, or they can identify assets already in existence and associate them to the ESP 100. For example, a broadcaster's existing infrastructure, video plant and archiving systems can be accessed, and previously created material can be used. Similarly, other content from content providers, such as newswire feeds, can be accessed and linked as an asset.

The method of editing individual assets 102 in the ESP 100 depends on the type of asset. In a presently preferred embodiment, common video, text, audio and other editing and authoring tools, such as Adobe PhotoShop™, Microsoft Word™, RealAudio™, RealVideo™, etc. are used, as appropriate, to edit the assets 102. Simple editing and authoring tools can also be built directly into system 20. For example, a video editor that permits an actor to select a video stream, and to create a video clip asset can be included. The video editor permits the actors to select In and Out Points on the stream and produce the video clip asset. The actor can then link the video clip asset to the ESP 100. Similarly, a text editor can be provided that permits an actor to edit a text asset, and associate it to the ESP 100.

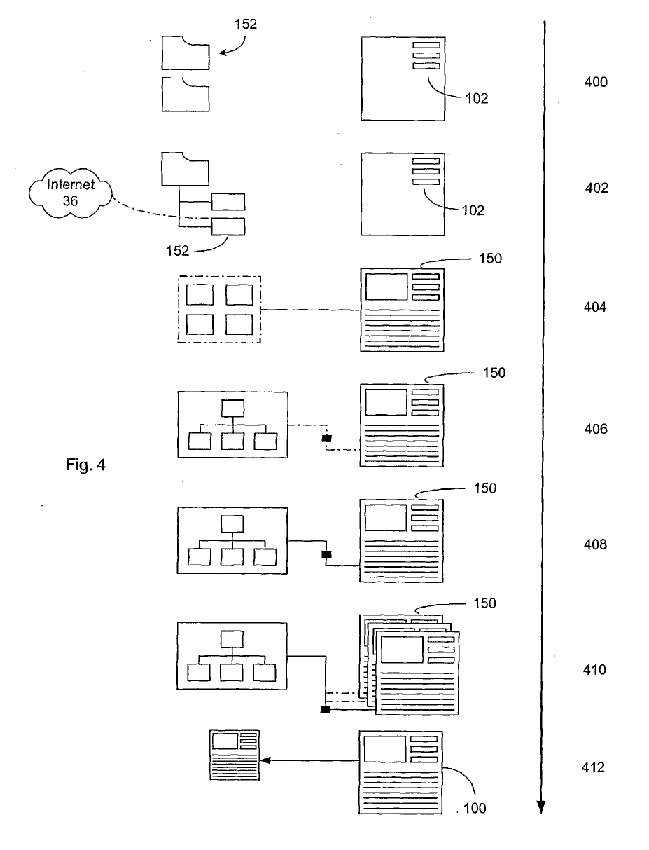

FIG. 4 shows the creation and life process for an ESP 100, as generally described above. First, at step 400, a producer or editor creates an ESP shell 150 that includes identification information, and research folders 152 if desired. The producer will typically assign tasks, such as asset creation, asset editing, research, etc. to various other actors at this stage. Reporters, researchers, video camerapeople, etc. then create, edit and/or retrieve suitable assets 102 for the ESP 100 at step 402. The research and creation can take place at locations remote from system 20, provided the actors have access to the Internet. Assets 102 are then organized or categorized, and added or associated to the ESP 100 at step 404. The producer, or director, then chooses publishing destinations, such as a broadcaster's Web site, TV, etc., at step 406, and templates are selected that match the chosen destinations. At step 408, the ESP 100 is made usable, and is published to the destinations, or platforms. At optional step 410, the ESP 100 can be updated, and new editions can be published, as above. Finally, at step 412, the ESP 100 is archived.

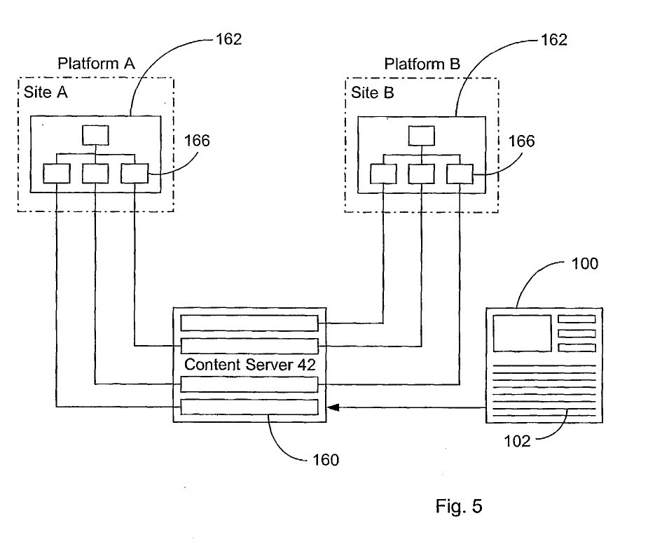

Referring to FIG. 5, the templating (or filtering) and publication steps are shown in more detail. Once the ESP 100 has been assembled, i.e. once its assets have been created, edited and linked, a publishing mechanism within the server 30 is initialized. The publishing mechanism consists of the server DBMS 42, or content server, that hosts multiple content sources 160. Each content source 160 can hold live assets 102 and ESPs 100 according to the category or type of source. Each site 162 on a particular platform or Web site 26, consists of site sections 166 that are mapped, or bound, to a specific content source 160. Site sections 166 provide the news production team with a simple system for managing and presenting ESPs. The content of each site section 166 determines where and how ESPs will be displayed on the broadcaster's Web site. For example, the contents of a site section called “Business” would determine what a viewer sees when they enter the “Business” section of the Web site. These elements can be ESPs or any other sort of assets. The template, or filter, for each site 162 specifies the site sections 166 that can be bound to that platform. When an ESP 100 is published in system 20, the filters for each platform specify which content sources 160 can be displayed on that platform, and the appropriate content (i.e. the assets in appropriate content sources) is mapped to the site section 166 on the platform.

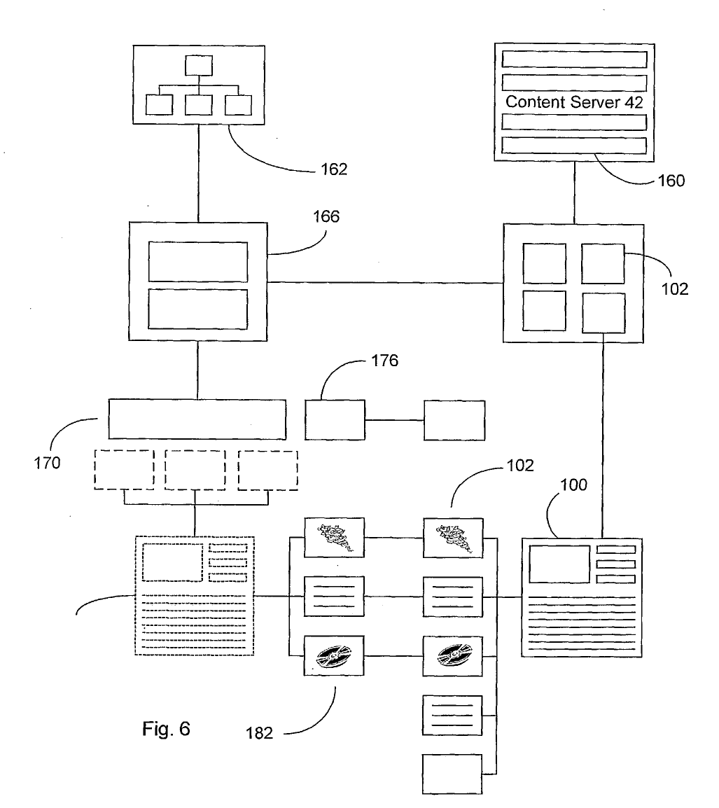

FIG. 6 shows the destination and publication application model for a presently preferred embodiment of the present invention. The actual mechanism by which the ESP 100 is published to various platforms is shown therein. The ESP 100 specifies the associations between the various assets 102. The assets 102 are organized according to content source 160, and their locations are stored in content server 42. Each site section 166 has a number of package slots 170 to hold a line up of ESPs 100, as well as individual asset slots 176 to hold assets not associated with ESPs. Each package slot 170 also has a number of associated templates 180. Each template 180 has number of asset slots 182 intended to contain specific assets associated with a particular ESP 100. When a site section 166 is mapped to a specific content source 160, it exposes its package slots 170 and its templates 180 to the ESP 100 added to the content source 160.

As an example of the above processes, let us assume that a TV news producer desires to create an ESP for a current event story, such as a hurricane in Texas. The producer sets up the ESP, and names it “Hurricane”. The producer then assigns a reporter and a cameraperson to cover the hurricane in situ. A researcher is assigned to the project to locate and retrieve background information on hurricanes in general, and previous hurricanes in Texas. A video editor, and other standard editing personnel are also assigned to the project.

As the hurricane approaches the coast, the reporter conducts interviews, and reports on the conditions. The reporter is connected to system 20 over the Internet, and downloads the reports as they are completed. The cameraperson does the same with video taken at the scene. These text and video assets are edited by appropriate editors, and associated to the ESP 100. Meanwhile, the researcher has located images and video footage of the destruction of past hurricanes, a Web site that describes the science of the hurricane and a meteorological site that provides up to the minute weather reports. These assets are also associated to the ESP 100, and a decision is made to publish the ESP 100 for access at a broadcaster's Web site by computer, by interactive digital TV and by handheld, Web-enabled devices. Clearly, the computer user and the TV user are able to receive and display all the assets associated with the ESP 100. However, the handheld user has only a limited alphanumeric screen and cannot display the video or image assets, therefore the content sources for video and image assets are not included in the template for the handheld platform. Appropriate templates are specified by the producer for each of the platforms, and the ESP 100 is simultaneously published to each platform, displaying only the appropriate content for that platform.

As the story evolves, the ESP 100 is updated with new reports (both video and text). The producer also decides to add a user poll to find out audience reaction to the storm. This interactive asset is added to the ESP 100, and the new edition of the ESP is published, again with the appropriate filters for the various platforms.

As will be apparent to those of skill in the art, the method and system of the present invention provide a convergence platform for creating, distributing and managing interactive news content to produce enhanced television programming, personalized news-on-demand and to simulcast interactive content on-air and online. Users can view headline news and have instant access to a wealth of related information. Broadcasters can create more secure relationships with their viewers and establish real two-way communication with them. By producing interactive news on multiple platforms, the present invention permits broadcasters to create new advertising shelf space and offer highly targeted advertising opportunities, such as ads targeted on a viewer-by-viewer or platform by platform basis.

The present invention incorporates advanced features and functionality for a diversified set of end-users. It allows broadcasters' Web and TV audiences to experience interactive news content using a personal computer, a television set-top box or a handheld and Web-enabled device. Unlike conventional television news programs, however, a consumer viewing the enhanced content of the present invention is able to access additional content by clicking on the streaming video “headline” with a computer mouse or television remote control. The additional content available to the consumer includes interactive graphics, video and audio clips or text stories on the same or related content. Advertising, cued to each individual's preferences, pops up automatically between stories and yields a targeted e-commerce opportunity. Therefore, the present invention combines the immediacy of video content, the information-rich nature of print publications, relevant advertisements, e-commerce and the interactivity of the Internet.

The present invention provides viewers with an online, video-centric news destination, including links to related information. All news stories, which are made available as streaming video and audio, are accompanied by supplemental text. Viewers search news content to pursue a story that is of special interest to them. Viewers also customize the viewing experience for themselves, allowing for personal taste and personal interest.

The present invention allows a news reporter to prepare an interactive news story, including text, graphics and audio and video clips, without the need for a Web development team or technical expertise. While researching a news story, for example, a reporter is able to access the broadcaster's password-protected Web site and, using the system 20, search the broadcaster's database of past video, audio and print content for relevant information. Once the story is complete, the present invention enables editors and producers to incorporate audio and video clips, graphics, interactive advertising and links to articles on the same or related content into the story. If a television broadcaster has relationships with several newspapers, for example, the present invention can be used to establish links from the broadcaster's Web site to related content on the Web sites of its print media partners. System 20 then distributes the finished news segment on-air and directly to the broadcaster's Web site, interactive TV or handheld and Web-enabled devices in real time. Finally, because the present system is accessible via the Internet, the reporter can produce and publish ESPs as easily from a hotel room in a foreign country as from the office or from home.

The present invention creates new online advertising “shelf space” and provides the opportunity for viewers to make purchases through these advertisements. Furthermore, system 20 facilitates brand building, attracts new viewers and cultivates new media skills for broadcast teams, while building the foundation for a variety of other information and entertainment products. The ESPs can be presented as stand-alone works, or integrated with internal broadcast systems.

The present invention automates video commercial ad insertion based on viewers' personal preferences and viewing habits. In addition, the present invention can track ad delivery and click-through rates to provide broadcasters with meaningful data to apply to e-commerce strategies.

The present invention also gives broadcasters a speed-to-market advantage in the competitive news environment. Journalists can publish interactive news packages instantly, reducing overall production time. When journalists assemble ESPs, they can publish simultaneously to multiple platforms. In this way, users maintain their brand continuity, regardless of the medium.

The present invention also takes users' broadcast products and enriches them with story-specific video-on-demand, text, graphics, polls and links to related information. Viewers interested in a particular story can delve as deep into the topic as they choose, simply by clicking on interactive screen graphics. One click of the remote control or mouse button will take them to the additional information. The present invention also integrates users' news with personalized information from other content providers, such as newswire feeds, weather information and stock quotes.

With the present invention, viewers can personalize how they experience the news. They choose everything they see, from their favorite news stories and sports, to their local weather forecast and stock information. This allows them to make the content work with their schedules. Personalized video playlists allow viewers to maximize their experience, while minimizing their time.

The present invention is Web-based and easy to use. This means the only tool required by a user is an Internet browser. It also means that journalists can access the software and publish a story from anywhere in the world—from the newsroom or on assignment—as long as they have Internet access. The system can be used with high-speed broadband connections or slower, modem dial-up connections. Because existing staff members can be easily trained to use system 20, their skill sets are enhanced and continue to increase as the technology improves and changes over time. The present system can also be easily integrated with users' existing infrastructures seamlessly, keeping costs down, since it interfaces with existing editing and authoring software.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for publishing enhanced story packages, comprising:
(i) providing a plurality of assets in a plurality of content sources;
(ii) associating the assets to form an enhanced story package;
(iii) providing at least one template for mapping the plurality of content sources to site sections on a platform;
(iv) publishing the enhanced story package for display on the platform.

2. The method of claim 1, wherein the step of providing the plurality of assets includes creating the plurality of assets.

3. The method of claim 1, wherein the step of providing the plurality of assets includes editing the plurality of assets.

4. The method of claim 1, wherein the step of providing the plurality of assets includes retrieving the plurality of assets.

5. The method of claim 1, wherein the step of associating the assets includes linking them.

6. The method of claim 1, wherein different templates are provided for different platforms.

7. The method of claim 6, wherein the step of publishing includes displaying different assets on different platforms.

8. An enhanced story package for an interactive publication, comprising:
a plurality of assets selected from different content sources; and
associations between the plurality of assets to permit their display on a publication platform.

9. The enhanced story package of claim 8, wherein the plurality of assets are chosen from media assets, interactive assets, and external assets.

10. The enhanced story package of claim 8, wherein the associations include links.

11. The enhanced story package of claim 8, wherein the assets are provided in Extended Markup Language.

12. The enhanced story package of claim 9, wherein the interactive assets include polls.

13. A system for publishing enhanced story packages, comprising:
a content server for maintaining assets in content sources, and for storing a profile of an enhanced story package associating a plurality of the assets;
a plurality of templates for specifying the content sources that can be displayed on each of a plurality of platforms; and
a publisher for publishing selected assets of the enhanced story package to the plurality of platforms according to their respective templates.

14. The system of claim 13, wherein the assets are chosen from media assets, interactive assets, and external assets.

15. The system of claim 13, wherein the plurality of platforms include interactive television, wireless-access-protocol and Web-enabled devices and general purpose computers provided with a Web browser.

16. The system of claim 13, further including a text editing tool for editing text-based assets.

17. The system of claim 13, further including a video editing tool for editing video-based assets.

18. The system of claim 14, wherein the interactive assets include polls.
